(19) United States
(12) Patent Application Publication
(10) Pub. No.: US 2025/0158508 A1
(43) Pub. Date: May 15, 2025

(54) PROVISION OF TWO MUTUALLY DIFFERENT ELECTRICAL DC VOLTAGES BY MEANS OF AN ENERGY CONVERTER

(71) Applicant: Inventronics GmbH, Garching (DE)

(72) Inventor: Joachim MÜHLSCHLEGEL, Gröbenzell (DE)

(21) Appl. No.: 18/836,022

(22) PCT Filed: Feb. 16, 2023
(86) PCT No.: PCT/EP2023/053898

§ 371 Date: Aug. 6, 2024

(30) Foreign Application Priority Data
Feb. 17, 2022 (DE) 10 2022 103 824.6

(51) Int. Cl. H02M 1/00; H02M 1/14; H02M 3/142; H02M 3/158

(52) U.S. Cl. CPC H02M 1/009; H02M 1/0009; H02M 1/0048; H02M 1/14; H02M 3/142; H02M 3/158

(57) ABSTRACT

A method for providing two mutually different electrical DC voltages, wherein a first of the two DC voltages, which has a greater voltage value than a second of the two DC voltages, is provided by means of a clocked energy converter by using a converter switching unit of the energy converter to apply electrical energy from an electrical energy source to a storage inductor of the energy converter and to supply an electric current of the storage inductor to a first electrical capacitor at which the first DC voltage is provided. The operation of the converter switching unit is controlled depending on a result of a first comparison of the first DC voltage with a first voltage comparison value.

### RELATED APPLICATIONS

This application is a US National Stage of International Application PCT/EP2023/053898, filed on 16 Feb. 2023 and claims priority under 35 U.S.C. § 119 (a) and 35 U.S.C. § 365 (b) from German patent application DE 10 2022 103 824.6 filed on 17 Feb. 2022, the contents of which are incorporated herein by reference in their entirety

### FIELD

Various embodiments of the present disclosure relate to clocked energy converters for providing two mutually different electrical DC voltages and to methods for providing two mutually different electrical DC voltages.

### BACKGROUND

Generic clocked energy converters are usually used to provide two mutually different electrical DC voltages essentially at the same time during intended operation. In at least one example, the two DC voltages to be provided use a common electrical reference potential or a common reference ground. However, the DC voltages can also be electrically isolated, for example galvanically isolated, from one another as needed by providing a suitable galvanic isolation unit.

The DC voltages can be used to realize an electrical energy supply of electronic units, for example control units or the like, such as, for example, for sensors, in particular in the automotive sector, but may also be intended for lighting devices, for example in the context of ballasts or the like. In this case, a particular problem proves to be being able to adjust or regulate the two DC voltages sufficiently accurately using a single clocked energy converter. Problems can arise during intended operation in the prior art particularly in the case of varying loads on the two DC voltages. In the prior art, provision is therefore made for the clocked energy converter for providing the two DC voltages to have a large adjustment reserve, as a result of which, in particular in a partial-load range, for example in a sleep mode (standby mode), a correspondingly high power loss usually occurs.

In this context, EP 2 716 134 B1 discloses a method for driving LED light sources, and a related apparatus. Furthermore, U.S. Pat. No. 10,447,168 B2 discloses an electronic converter and a related method for operating an electronic converter. Even if this prior art has proven its worth, there is still a need for improvement. Improving efficiency is desired in particular when there is a low power demand on the first and the second DC voltage from electric loads or electronic devices connected to said DC voltages. For example, this relates to the sleep mode of the device, for example of the lighting device or the like, that is accordingly supplied by the clocked energy converter. In sleep mode, a particularly lower power consumption is usually desired so as, in particular in the case that the clocked energy converter is electrically coupled to the electrical energy source permanently, to keep the load thereon as small as possible. As a result, it should be possible to save energy overall.

### SUMMARY

Various embodiments of the present disclosure relate to improving energy conversion methods and to clocked energy converters to the effect that the energy efficiency, in particular in the partial-load range, for example, in a sleep mode, can be improved.

With regard to a methods described herein, various embodiments of the present disclosure relate to supplying electric current of the storage inductor to the first electrical capacitor depending on a switching state of a secondary switching unit if the secondary switching unit occupies a first switching state, wherein the electric current of the storage inductor is supplied to a second electrical capacitor depending on the switching state of the secondary switching unit if the secondary switching unit occupies a second switching state, wherein the second DC voltage is provided at the second electrical capacitor, wherein the switching state of the secondary switching unit is controlled depending on a result of a comparison of the second DC voltage with a second voltage comparison value.

With regard to clocked energy converters described herein, various embodiments of the disclosure relate to energy converters having a second electrical capacitor for providing the second DC voltage, and a secondary switching unit which is electrically coupled to the storage inductor and to the first and second electrical capacitors in order to supply the electric current of the storage inductor either to the first electrical capacitor or to the second electrical capacitor depending on a switching state of the secondary switching unit, and wherein the energy converter is designed to control the switching state of the secondary switching unit depending on a result of a comparison of the second DC voltage with a second voltage comparison value.

Various embodiments of the present disclosure proceed from a clocked energy converter which is designed to provide a single DC voltage. Such a clocked energy converter can for example be in the form of a boost converter (booster), a buck converter (buck), a combination thereof, in the form of a DC-DC converter or the like. The clocked energy converter can be designed to be supplied with a DC voltage from the electrical energy source. However, there is in principle also the possibility that the clocked energy converter is designed to have an AC voltage of the electrical energy source applied to it. Of course, combinations thereof can also be provided. The energy converter can have a single-level or else multi-level design. An, in particular single-level, energy converter of the generic type has in most cases at least one electronic switching element, in particular a transistor, a thyristor, or the like, which interacts with the storage inductor. This switching element is often combined with a diode in order to be able to achieve the desired conversion effect. A second electronic switching element can of course be used instead of the diode. The transistor can for example be a bipolar transistor but can also be a field-effect transistor, in particular a MOSFET, an IGBT or the like. However, a thyristor arrangement, in particular a GTO or the like, can also in principle be used as the electronic switching element.

In terms of a lighting apparatus, it is in particular proposed that the lighting apparatus has a clocked electronic energy converter according to at least one aspect of the present disclosure which, as a load, supplies electrical energy to a lamp so as to be able to control its power. The lighting apparatus according to at least one aspect of the present disclosure accordingly has the same effects and advantages as the energy converter described in embodiments of the present disclosure.

Various embodiments of the present disclosure can be based, inter alia, on the idea of being able to provide the second DC voltage by means of the energy converter that provides the first DC voltage, without loading the first DC voltage itself for this purpose during intended operation due to an electrical actuator drawing electrical energy from the first electrical capacitor and supplying it to the second electrical capacitor, for example. Rather, in the case of at least one aspect of the present disclosure, the energy for the first and the second electrical DC voltage is supplied directly from the storage inductor via the secondary switching unit.

With regard to the first DC voltage and the regulation functionality therefor, the voltage regulation characteristic, which is controlled by means of the converter switching unit depending on the result of the first, as in the case of an energy converter that only needs to provide a single DC voltage can be retained.

In principle, essentially no change therefore needs to be made with regard to the clocked energy converter regarding the first DC voltage which has the greater voltage value with respect to the second DC voltage. In this respect, embodiments of the present disclosure can be even suitable for retrofitting already known constructions for clocked energy converters.

Various embodiments of the present disclosure can use the secondary switching unit to be able to supply electric current provided by the storage inductor in particular either to the first capacitor or to the second capacitor depending on the switching state of said secondary switching unit. This means, in a first switching state of the secondary switching unit, provision is, for example, made for the electric current of the storage inductor to be supplied to the first capacitor and therefore for electrical energy to be able to be made available for electric loads connected to the first DC voltage. In a second switching state of the secondary switching unit, the supply of current from the storage inductor to the first electrical capacitor is, for example, interrupted. Instead, the electric current is now supplied to the second electrical capacitor.

The regulation functionality with regard to the converter switching unit is, for example, kept essentially unchanged during this second switching state too. This means, if an energy requirement for the first DC voltage results from the first comparison of the first DC voltage with the first voltage comparison value, this energy requirement thus, for example, continues to remain decisive for controlling the converter switching unit. Due to the fact that the electric current supplied from the storage inductor to the second electrical capacitor is not available for the first DC voltage, this regulation state remains at least maintained; depending on the load on the first DC voltage, the power requirement may even increase. However, the electrical power converted by means of the energy converter and the converter switching unit is now supplied to the second electrical capacitor and to the electric loads connected to the second electrical DC voltage. In the case of sufficient electrical power being supplied, the second DC voltage can therefore be maintained or increased. As soon as, on account of the result of the second comparison, the secondary switching unit is switched back to the first switching state again, the electric current of the storage inductor is supplied to the first capacitor again and the first DC voltage is accordingly supported.

The first voltage comparison value is a voltage comparison value which corresponds to a desired value of the first DC voltage, for example a first setpoint value. The first voltage comparison value is, for example, a value which corresponds to a desired voltage value for the first DC voltage. The same also applies for the further voltage comparison values, in particular for the second voltage comparison value. The voltage comparison value can also have an upper and a lower value which are spaced apart from one another and can define a tolerance band, for example.

Controlling the switching over of the secondary switching unit from the first switching state to the second switching state or vice versa is controlled depending on the result of the second comparison. The second voltage comparison value is, for example, a value which corresponds to a desired voltage value for the second DC voltage. This second voltage comparison value is therefore usually lower than the first voltage comparison value. If the result from the second comparison is that an actual value of the second DC voltage is greater than the second voltage comparison value, a corresponding switching signal can be output to the secondary switching unit which then switches over from the second switching state to the first switching state such that the electric current of the storage inductor is no longer supplied to the second electrical capacitor but to the first electrical capacitor instead.

As a result, a complete regulation circuit with regard to the first DC voltage can now be created again.

The capacitance values of the first and second electrical capacitors are suitably selected such that a desired predefined regulation tolerance with regard to the first and/or the second electrical DC voltage can be achieved.

From the aforementioned functional description, it is apparent that, in the first switching state of the secondary switching unit, the clocked energy converter in principle functions just like a clocked energy converter of the prior art which is only able to provide a single electrical DC voltage. The additional arrangement of the secondary switching unit in connection with the second electrical capacitor therefore makes it possible to additionally produce the second electrical DC voltage without needing to intervene in the existing control or regulation concept of the clocked energy converter with regard to the first DC voltage. Rather, separate regulation can be used here to branch off electrical power for the second regulation circuit with regard to the second DC voltage from the first regulation circuit as needed. This makes it possible to achieve a particularly simple and convenient concept which allows a particularly low energy consumption to be provided at the same time, particularly in the case of low power, in particular in a sleep mode. As a result, energy can in particular be saved, particularly when the clocked energy converter is supplied with electrical energy from the electrical energy source essentially permanently.

The storage inductor of the energy converter is, for example, an electronic component, for example in the form of an electronic coil or a transformer, which can be coupled to the electrical energy source by means of the converter switching unit as needed. The converter switching unit can have one or more electronic switching elements, in particular transistors, for this purpose.

A switching element or an electronic switching element, in particular a semiconductor switch, in the context of this disclosure, is, for example, a controllable electronic switching element, for example a transistor, a thyristor, combination circuits thereof, in particular with freewheeling diodes connected in parallel, for example a metal-oxide-semiconductor field-effect transistor (MOSFET), an insulated-gate bipolar transistor (IGBT), for example, with integrated freewheeling diodes, or the like. The switching element is operated in switching operation.

The switching operation of the semiconductor switch in the form of a transistor means that, in a switched-on switching state between the connections of the transistor that form the switching path, a very low electrical resistance is provided such that a high current flow is possible for a very low residual voltage. In the switched-off switching state, the switching path of the transistor has a high impedance, that is to say it provides a high electrical resistance, such that essentially no or only a very small, in particular negligible, current flow is present even when a high voltage is present in the switching path. Linear operation in transistors differs from this. The secondary switching unit can likewise have one or more electronic switching elements in order to be able to provide the desired switching functionality. In at least one example, the switching elements are provided with a control connection which is electrically coupled to a corresponding control unit of the clocked energy converter. As a result, corresponding switching signals from the control unit can be applied to the switching elements such that the desired switching operation can be performed. The secondary switching unit is, for example, a constituent part of the energy converter. The function of the second comparison can be provided by the energy converter, in particular the secondary switching unit. The function of the second comparison can for example be provided by means of the control unit.

The control unit can take over or provide functions with regard to the control of the converter switching unit and of the secondary switching unit, in particular with regard to the operation of the switching elements, the provision of the DC voltages by the energy converter and/or the like. The control unit can be designed to be electrically isolated from the converter switching unit and/or the secondary switching unit and can, for example, be connected to said units in a galvanically isolated manner. The control unit itself can be provided as a separate unit. However, it is, in at least one example, a constituent part of the energy converter and, for example, arranged to be integrated in the latter. The control unit can in principle be at least in part or else completely in the form of an electronic hardware circuit. In addition, the control unit can be formed at least in part or else completely by a computer unit which is controlled by means of a suitable computer program in order to be able to provide the desired functionality. The secondary switching unit and/or the converter switching unit can additionally also have one or more diodes for the intended operation.

Various embodiments of the present disclosure can thus make it possible to improve the energy efficiency compared to the prior art, particularly in the partial-load range, wherein the addition according to at least one aspect of the present disclosure makes it possible to realize a reliable, stably functioning concept for providing two electrical DC voltages, namely with little effort. The operation of the secondary switching unit therefore usually does not disrupt the operation of the converter switching unit.

According to one development, it is proposed that the switching state of the secondary switching unit is controlled independently of a switching operation of the converter switching unit. Various embodiments of the present disclosure namely allows the operation of the secondary switching unit to be able to be decoupled from the switching operation of the converter switching unit. As a result, it is possible to provide control or regulation operations that are independent of one another regarding the switching operation of the converter switching unit and regarding the switching operation of the secondary switching unit with regard to their at least two switching states. As a result, it is also possible for the clocked energy converter to be able to have a modular construction, which can reduce the effort involved in its production. In addition, reliable operation can be easily achieved in a wide variety of load and/or operating states. A clock-pulse rate of the secondary switching unit can therefore differ from a clock-pulse rate of the converter switching unit, and may even vary substantially independently therefrom.

It is furthermore proposed that the switching state of the secondary switching unit is controlled depending on a result of a third comparison of the electric current of the storage inductor with a current comparison value. In at least one instance, this development is provided at least for the second switching state of the secondary switching unit or even only for the second switching state of the secondary switching unit. For example, this makes it possible to achieve that a predefined current is not undershot and/or not exceeded. Particularly advantageously, it can be achieved that a minimum current can be permanently ensured, in particular in the second switching state of the secondary switching unit. This can be advantageous for the intended operation, as will be explained in further detail below. In addition, however, provision can also be made, through appropriate selection of the current comparison value, for the supplied electric current to be zero at least for a predefined period of time or—depending on construction—to possibly even be negative. As a result—depending on the construction of the secondary switching unit—the reliable operation of the secondary switching unit can be supported. Overall, the function of the clocked energy converter can be further improved. The carrying out of the third comparison can be predefined at predefined points in time and/or in one or more predefined time periods. Provision can be made for the third comparison to be carried out non-continuously.

According to one development, it is proposed that the switching state of the secondary switching unit is controlled depending on an operating state of an in-phase regulator unit connected to the second electrical capacitor. The in-phase regulator unit can be used to provide a third DC voltage which is dependent on the second DC voltage and which is provided with a high quality, in particular a high stability or accuracy. In particular, voltage fluctuations, for example due to the switching operation of the secondary switching unit and/or of the converter switching unit, can be reduced. This is advantageous for example for voltage-sensitive electronic loads which are intended to be supplied with electrical energy via the second DC voltage and the reliable intended operation of which requires as stable a reliable voltage supply as possible. For example, the in-phase regulator unit can be provided to supply electrical energy to a computer unit, for example in the form of a microcontroller, an analog-to-digital converter, a digital-to-analog converter and/or the like. The operation of the secondary switching unit can therefore be controlled depending on a voltage supply requirement for the in-phase regulator unit such that the in-phase regulator unit is able to provide as stable and accurate a third DC voltage as possible which is supplied with electrical energy from the second DC voltage. It is thereby also possible for example to keep a voltage difference between the second DC voltage and the third DC voltage, which is responsible for a corresponding power loss at the in-phase regulator unit, as low as possible.

It is furthermore proposed that electrical energy of the first electrical capacitor is supplied to the second electrical capacitor via a coupling circuit depending on a result of a fourth comparison of the second DC voltage with a third voltage comparison value. The third voltage comparison value is, for example, less than the second voltage comparison value. This configuration makes it possible to additionally branch off electrical energy from the first electrical DC voltage to the second electrical DC voltage as needed. This is particularly advantageous for example in the case of disruptions to the electrical energy supply from the electrical energy source, for example in the case of a power failure or energy failure or in the case of an undervoltage or the like. As a result, if the intended operation of the clocked energy converter can no longer ensure the provision of the DC voltages, additional support of the second DC voltage can be achieved. By virtue of the fact that the coupling circuit can at least temporarily allow an energy supply of the second electrical DC voltage, it can be achieved that loads connected to the second DC voltage can back up data and store operating states on account of a corresponding control signal before the energy supply of the second DC voltage fails.

As a result, the reliability and operational safety can be improved overall.

The coupling circuit can for example have a voltage sensor which makes it possible to detect a corresponding disruption. The voltage sensor can output a corresponding control signal to an electronic switching and/or control element, for example a transistor or the like, in order to be able to establish a corresponding energy coupling so that electrical energy can be transferred from the first capacitor to the second capacitor or else to the in-phase regulator. As a result, the second or the third DC voltage can be maintained as long as possible.

It is furthermore proposed that the second DC voltage is regulated by means of the secondary switching unit to a voltage value greater than a minimum electrical voltage required for intended operation of the in-phase regulator unit. As a result, the reliable operation of the in-phase regulator unit can be improved.

Moreover, it is proposed that a clock-pulse rate of the secondary switching unit is greater than half a clock-pulse rate of the converter switching unit on average over time. As a result, fast regulation or control can be achieved such that the second DC voltage can also be adjusted or regulated with high accuracy and speed. The clock-pulse rates can be selected in a range of a few hundred Hertz up to a few 100 kHz. In addition, it is proposed that the second voltage comparison value selected is a value at least 1 V lower than the first voltage comparison value. As a result, the reliable functioning of the secondary switching unit can be further improved. In particular, decoupling of the first DC voltage from the second DC voltage can be supported.

It is furthermore proposed that the secondary switching unit has a power converter unit. The power converter unit is a unit which only allows a current flow of the electric current in a respective preferred direction. The power converter unit can usually have one or more diodes. Alternatively or additionally, the power converter unit can also have one or more transistors which are accordingly controlled by means of the control unit such that the desired current flow can be realized. Of course, combinations thereof can also be provided. For example, the power converter unit can have two diodes which, depending on the type of the clocked energy converter, are electrically connected to one another on the cathode side or on the anode side, wherein the middle connection thus formed is electrically coupled to the electrical storage inductor. The respective other electrodes of the two diodes can then be electrically coupled to the respective first or second electrical capacitor. As a result, it is possible to direct the current flow of the electric current either to the first electrical capacitor or to the second electrical capacitor. In order to be able to control the current flow to the first or second electrical capacitor, provision is, for example, made for a corresponding switching element in the secondary switching unit, which switching element can be used to control the current flow to the second electrical capacitor. By virtue of the fact that the second DC voltage has a lower voltage value than the first DC voltage, it can therefore be achieved that, in the switched-on state of the switching element, the current flow is automatically directed to the second capacitor via the power converter unit. Conversely, if the switching element is in the switched-off switching state, a current flow of the electric current to the first electrical capacitor via the power converter unit thus automatically arises. As a result, the function of the secondary switching unit can be realized by this combination. Other constructions which are able to provide a corresponding functionality are of course also possible.

For example, provision can be made for the power converter unit itself to have two switching elements which are operated alternately in switching operation and which, connected in series, provide a middle connection which is electrically coupled to the storage inductor. The respective other connections are electrically coupled to the respective first or second electrical capacitor. By alternately switching, the current flow of the electric current of the storage inductor can therefore also be controlled here.

The power converter unit, for example, has at least one diode, one electrode of which is electrically connected to the storage inductor and the second electrode of which is electrically coupled to the first electrical capacitor. As a result, the first electrical DC voltage can be electrically decoupled from the second electrical DC voltage. For instance, in the case of a positive electrical first and second DC voltage, an anode electrode of the diode is electrically connected to the storage inductor and a cathode electrode of the diode is electrically coupled to the first electrical capacitor. In this case, the secondary switching unit can also be connected, for example, directly, to the storage inductor or be electrically coupled to the latter.

Particularly advantageously, it is proposed that the power converter unit has at least two diodes, the anode electrodes or cathode electrodes of which are electrically connected to one another and to the storage inductor, wherein the respective other electrodes are electrically coupled to the respective one of the electrical capacitors.

As a result, particularly simple control of the current flow of the electric current of the storage inductor with regard to the first or second electrical capacitor can be achieved. It is particularly advantageous in this respect that the diodes do not need to be controlled; corresponding effort can therefore be saved. As already explained previously, only a single switching element is required. The diode between the storage inductor and the second electrical capacitor can for example be used, inter alia, to be able to adjust a function of the secondary switching unit, as will be explained in further detail below. In order to provide positive electrical DC voltages, the anode electrodes of the diodes, in at least one example, are electrically connected to one another and to the storage inductor. However, in principle, provision could also be made for negative electrical DC voltages to be provided. In this case, for example, the cathode electrodes of the diodes can be electrically connected to one another and to the storage inductor.

Particularly advantageously, it is proposed that the secondary switching unit has a thyristor functional unit which is at least in part connected in series with the power converter unit with regard to the electric current supplied to the second capacitor. In at least one instance, the thyristor functional unit can be connected, for example, directly, to the storage inductor or be electrically coupled to the latter. The thyristor unit has the advantage that control effort can be kept low. The thyristor functional unit provides the function of a thyristor. For example, the thyristor functional unit can be formed by a single component as thyristor. Particularly advantageously, however, the thyristor functional unit can be realized by a circuit comprising two transistors which allows it to be able to adjust specific functional variables of the thyristor functional unit, for example a holding current or the like. For example, the diode of the power converter unit between the storage inductor and the second electrical capacitor can be used, inter alia, to be able to at least partially adjust the function of the thyristor functional unit, in particular with regard to the holding current. This makes it possible to create, with little effort, a fast-reacting thyristor functional unit that is able to be constructed in a specific manner.

The thyristor functional unit can take over the function of the switching element in the secondary switching unit. Provision can also be made, as needed, for two or more thyristor functional units which can be connected in parallel or in series as needed. In addition, provision can also be made for a thyristor functional unit for a respective coupling to the first or second electrical capacitor in each case. Further constructions are conceivable.

It is furthermore proposed that the thyristor functional unit has a thyristor circuit with two bipolar transistors and at least one electrical resistor which is electrically coupled to a collector of one of the transistors, in order to adjust a holding current of the thyristor functional unit by means of the electrical resistor. As a result, a particularly inexpensive and simple implementation of the thyristor functional unit can be achieved. Using bipolar transistors additionally makes it possible to achieve a high switching speed such that, in particular in the interaction with the first converter switching unit, good functionality can be achieved which allows high accuracy with regard to adjusting the second DC voltage. In particular, the diode between the storage inductor and the second electrical capacitor can for example be used, inter alia, connected in series with the electrical resistor, to be able to at least partially adjust the holding current. For example, a non-linear characteristic curve can also be achieved in order to allow, for example, a “harder” characteristic curve compared to the exclusive use of the resistor. In addition, a resistance value can be selected to be lower when using the diode because a relevant electrical voltage is already present across the diode for a comparatively small electric current. Power loss can thus also be small in this range.

It is furthermore proposed that the thyristor circuit arrangement has a stabilization capacitor which is connected at least between the collector of one of the transistors and an emitter of the other of the transistors. The function of the thyristor circuit arrangement can thus be stabilized. An undesired tendency for the thyristor circuit arrangement to oscillate can be reduced. A capacitance of the stabilization capacitor can, for example, be selected to be as small as possible but large enough that stable functionality during intended operation can be ensured. For example, the capacitance can be a few pF to a few nF. Advantageously, the capacitance is in a range from approximately 330 pF to approximately 3.3 nF.

According to one development, it is proposed that the energy converter has a potential circuit which is designed to apply a, for example, fixed, predefined electrical potential to a control connection of the thyristor functional unit during intended operation. The potential circuit is used to apply a predefined electrical potential to the control connection. In particular, the second electrical reference voltage can thus also be provided at the same time. For example, the function of the second comparison can thus also be provided at least in part by the thyristor functional unit itself. As a result, separate means for carrying out the second comparison can at least in part be saved. The thyristor functional unit can then be triggered, for example, by virtue of a potential difference between the control connection and a connection of the thyristor functional unit that is electrically coupled to the second electrical capacitor exceeding a predefined value. The second comparison can thus be performed. In order to provide the constant electrical potential, the potential circuit can use a constant voltage source and/or a constant current source and have, for example, corresponding electronic components. As a result, control effort for the thyristor functional unit can be very low. This furthermore allows the thyristor functional unit itself to be able to perform the second comparison and so no demands need to be made on the control unit.

The features and combinations of features specified above in the description, and the features and combinations of features mentioned in the following description of exemplary embodiments and/or shown in the figures themselves, can not only be used in the respectively specified combination but also in other combinations. Implementations of the present disclosure which are not explicitly explained and shown in the figures but which arise from and are able to be produced by separate combinations of features from the explained embodiments are therefore also encompassed or considered to be disclosed. The features, functions and/or effects illustrated on the basis of the exemplary embodiments can, taken on their own, each represent individual features, functions and/or effects of the present disclosure that are to be considered independently of one another and which each also further develop the present disclosure independently of one another. The exemplary embodiments should therefore also comprise combinations other those in the explained embodiments. In addition, the described embodiments can also be supplemented by other features, functions and/or effects of the present disclosure that have already been described.

### BRIEF DESCRIPTION OF THE DRAWINGS

The features and combinations of features mentioned above in the description, and the features and combinations of features mentioned below in the description of the figures and/or shown in the figures themselves, can not only be used in the respectively specified combination but also in other combinations without leaving the scope of the present disclosure. In the figures, identical reference signs denote identical features or functions.

In the figures:

FIG. 1 shows, in a schematic circuit diagram illustration, a circuit diagram of an energy converter for providing two electrical DC voltages, wherein a first of the two DC voltages has a greater voltage value than a second of the two DC voltages, wherein the second DC voltage supplies power to an in-phase regulator for providing a third DC voltage;

FIG. 2 shows, in a schematic diagram illustration, by means of respective graphs, illustrations of the first, the second and the third DC voltage and, by means of a fourth graph, a current flow through a storage inductor of the energy converter according to FIG. 1 over a period of time;

FIG. 3 shows a schematic diagram illustration as in FIG. 2 with an extended time section from the diagram illustration according to FIG. 2, wherein during intended operation the DC voltages supply electrical energy to electric loads which are not illustrated;

FIG. 4 shows a schematic diagram illustration as in FIG. 2, wherein the energy converter is operated in a sleep mode in which the first DC voltage is essentially unloaded and the second or third DC voltage is loaded with a small quiescent current in the region of approximately 3 mA;

FIG. 5 shows a schematically extended diagram illustration as in FIG. 3 for the operating state according to FIG. 4.

### DETAILED DESCRIPTION

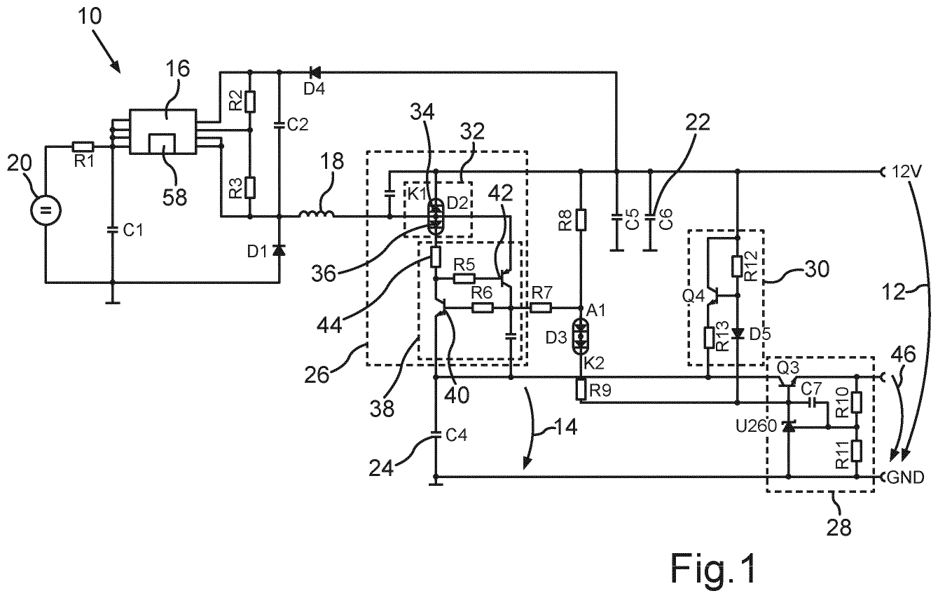

FIG. 1 shows, in a schematic circuit diagram illustration, an energy converter 10 in the form of a DC-DC converter. The energy converter 10 is used to provide two mutually different electrical DC voltages 12, 14. An in-phase regulator 28 which provides a third DC voltage 46 is connected to the second DC voltage 14. The first DC voltage 12 and the third DC voltage 46 are provided at electrical connections of the energy converter 10 that are not denoted. Electric loads can be connected to these connections for the purpose of being supplied with electrical energy.

The input side of the energy converter 10 is connected to an electrical energy source 20 which in the present case provides a pulsating DC voltage. The pulsating DC voltage can for example be provided by rectifying an AC voltage, for example an AC voltage of a public energy supply grid or the like. In principle, however, the DC voltage can also be provided as a smoothed DC voltage, for example from an electrical energy store such as a battery, an accumulator, a power supply unit and/or the like. The basic function of a buck converter is known to the person skilled in the art, for which reason detailed explanations in this regard are omitted.

The energy converter 10 further has a converter switching unit 16 which is able to be electrically coupled to the electrical energy source 20 and which, together with a storage inductor 18, which is electrically coupled to the converter switching unit 16, and a diode D1, provides the function of a buck converter. In the present case, the converter switching unit 16 is formed by an integrated circuit which, in addition to a switching element which in the present case is formed by a field-effect transistor that is not illustrated, also comprises a required control unit 58 for operating the switching element.

The storage inductor 18 is in the form of an electronic coil in the present case. The storage inductor 18 is electrically connected to the switching element of the converter switching unit 16 such that the storage inductor 19 can be connected to the electrical energy source 20 depending on a switching state of the switching element, operated in switching operation, of the converter switching unit 16.

The energy converter 10 further has two capacitors which are connected in parallel in the present case and which comprise a first electrical capacitor 22 for providing the first of the two DC voltages 12, 14. In the present case, the first DC voltage 12 has a voltage value of approximately 12 V. The first electrical capacitor 22 is electrically coupled to the storage inductor 18, as will be explained in further detail below. Even if a parallel connection comprising two capacitors is provided for the first electrical capacitor 22 in the present case, it is also possible-depending on construction—to provide a single capacitor 22 as a component here.

The energy converter 10 further has the control unit 58. The control unit 58 for the energy converter 10 is integrally comprised by the converter switching unit 16 in the present case. In the present case, the first DC voltage 12 is used to simultaneously supply energy to the converter switching unit 16 via a diode D4 and a capacitor C2. In addition, a voltage divider comprising the electrical resistors R2, R3 is provided in parallel with the capacitor C2. A center tap of this series connection is likewise connected to the converter switching unit 16. It is used to measure the first DC voltage 12 for regulation purposes. This involves measuring the actual value of the first DC voltage 12.

The control unit 58 of the converter switching unit 16 compares this measured voltage value and carries out a first comparison with a first voltage comparison value. This voltage comparison value corresponds to a voltage value of approximately 12 V. This makes it possible to provide a regulation functionality by means of the control unit 58 of the converter switching unit 16, whereby the switching element of the converter switching unit 16 is operated in switching operation in such a way that the first DC voltage is regulated to 12 V.

The energy converter 10 further has a second electrical capacitor 24 for providing the second DC voltage 14. The second DC voltage 14 has a lower voltage value than the first DC voltage 12, in the present case a voltage value of approximately 4.5 V.

The energy converter 10 further has a secondary switching unit 26 which is electrically coupled to the storage inductor 18 and to the first and second electrical capacitors 22, 24 in order to supply the electric current of the storage inductor 18 either to the first electrical capacitor 22 or to the second electrical capacitor 24 depending on a switching state of the secondary switching unit 26. The secondary switching unit 26 is designed to control the switching state of the secondary switching unit 26 depending on a result of a second comparison of the second DC voltage 14 with a second voltage comparison value. In the present case, the second voltage comparison value is approximately 4.5 V.

In the present case, the secondary switching unit 26 has a power converter unit 32 which for its part has two diodes 34, 36, the anodes of which are electrically connected to one another and to the storage inductor 18. The respective other electrodes, or cathodes, of the diodes 34, 36 are electrically coupled to the respective electrical capacitors 22, 24. In the present case, the cathode of the diode 34 is coupled directly to the first electrical capacitor 22, whereas the cathode of the second diode 36 is electrically coupled to the second electrical capacitor 24 via a thyristor functional unit 38 described below. The function of the secondary switching unit 26 arises from an interaction of the power converter unit 32 with the thyristor functional unit 38, as will be explained below. The thyristor functional unit 38 is connected in series with the power converter unit 32 with regard to the electric current supplied to the second capacitor 24.

In the present configuration, provision is made that the thyristor functional unit 38 has a thyristor circuit with two bipolar transistors 40, 42. The transistor 40 is an NPN transistor, whereas the transistor 42 is a PNP transistor. A collector of the transistor 42 is connected to a base of the transistor 42 via an electrical resistor R5, whereas a collector of the transistor 42 is electrically coupled to the base of the transistor 42 via an electrical resistor R6. Furthermore, an emitter of the transistor 42 is electrically connected to the storage inductor 18 and to the anodes of the diodes 34, 36. An emitter of the transistor 40 is electrically connected to the second electrical capacitor 24. Furthermore, the collector of the transistor 40 is electrically connected to the cathode of the diode 36 via an electrical resistor 44. The electrical resistor 44 can be used to adjust a holding current of the thyristor functional circuit 38.

The thyristor functional circuit 38 provides the function of a thyristor in principle. The basic function of a thyristor is known to the person skilled in the art, for which reason detailed explanations in this regard are omitted in the present case. As will be explained in more detail below, a control connection is provided at the collector of the transistor 42 via an electrical resistor R7. This control connection is used to switch on the thyristor functional unit 38 formed by the transistors 40, 42 and the aforementioned corresponding further components. As is known, the thyristor functional unit 38 is switched off again by the holding current being undershot. This is explained in more detail below.

So long as the thyristor functional unit 38 is in the switched off switching state, the electric current of the storage inductor 18 is supplied to the first electrical capacitor 22 via the diode 34. In this operating state, the energy converter 10 functions, during intended operation, just like an ordinary buck converter for providing the first DC voltage 12. This is regulated to the predefined voltage value by means of the converter switching unit 16. For this purpose, the switching element, which is not illustrated, of the converter switching unit 16 is operated in pulse-width modulation (PWM) operation, for example. This functional principle is in principle likewise known to the person skilled in the art, for which reason detailed explanations in this regard are also omitted in the present case.

The thyristor functional unit 38 can be switched on by virtue of a suitable voltage difference being provided between the emitter of the transistor 40 and the collector of the transistor 42. For this purpose, the electrical potential across the resistor R7 is stabilized via a voltage divider comprising electrical resistors R8, R9 and a voltage reference U260. This voltage divider is supplied with power from the first regulated DC voltage 12. A substantially constant electrical potential is therefore provided at the control connection. A potential difference between the control connection and the connection of the thyristor functional unit 38, which is electrically coupled to the second electrical capacitor, is therefore used to trigger the thyristor functional unit 38.

Furthermore, a capacitor C3 is connected to the electrical resistor R7. As a result, hysteresis with regard to the switching function of the thyristor functional unit 38 can be realized so that the thyristor functional unit 38 does not for example change to the switched-off switching state too soon when the holding current is reached.

As energy consumption in the region of the second DC voltage 14 or of the third DC voltage 46 increases, the second DC voltage 14 decreases in the switched-off switching state of the thyristor functional unit 38. So long as a sufficient voltage difference across the in-phase regulator unit 28 is available, the in-phase regulator unit 28 can be used to keep the third DC voltage 46 constant.

Decreasing the second DC voltage 14 causes the potential difference between the collector of the transistor 42 and the emitter of the transistor 40 to increase such that the thyristor functional unit 38 changes to the switched-on switching state when a switching threshold is exceeded, namely just like takes place in a thyristor in principle.

The thyristor functional unit 38 thus carries out a second comparison. As a result and because the second DC voltage 14 is lower than the first DC voltage 12, the electric current of the storage inductor 18 is now no longer supplied to the first capacitor 22 via the diode 34 but instead to the second capacitor 24 via the second diode 36 and the thyristor functional unit 38 and charges this capacitor.

The current flow is maintained until the holding current of the thyristor functional unit 38 is undershot. The current to the second electrical capacitor 24 decreases as the second DC voltage 14 increases. As soon as the holding current of the thyristor functional circuit 38 is undershot, the thyristor functional circuit 38 transitions to the switched-off switching state. The electric current of the storage inductor 18 then commutates via the diode 34 to the first capacitor 22.

In the switched-on switching state of the thyristor functional unit 38, the regulation circuit with regard to the converter switching unit 16 is maintained. However, due to the fact that the electric current of the storage inductor 18 does not reach the first electrical capacitor 22, energy is furthermore provided via the converter switching unit 16 by means of the suitable switching operation, which energy is used to charge the second capacitor 24. Only when this capacitor has been sufficiently charged does it become possible again to charge the first electrical capacitor 22 by switching off the thyristor functional unit 38 so that the regulation functionality of the converter switching unit 16 can be completed again. By virtue of this construction according to the present disclosure, energy can therefore be branched off from the superordinate regulation circuit with regard to the first DC voltage 12 for the provision of the second DC voltage 14. In this case, the regulation function with regard to the first DC voltage 12 is essentially unimpaired.

As is known, the in-phase regulator unit 28 has an NPN transistor Q3, the collector of which is electrically connected to the second capacitor 24 and the emitter of which provides the third DC voltage 46. A base of the transistor Q3 is connected to the voltage reference U260 which, for its part, is coupled to a middle connection of a voltage divider comprising electrical resistors R10, R11. The voltage divider is connected to connection terminals for the third DC voltage 46. As a result, in-phase regulation can be provided in a manner known to the person skilled in the art. The base of the transistor Q3 is furthermore connected to the resistor R9 so that an energy supply for the regulation element U260 is available.

As will be shown further below, the value of the second DC voltage 14 is selected such that the intended operation of the in-phase regulator unit 28 can be realized. At the same time, however, the value of the second DC voltage 14 is selected to be low enough that a power loss at the transistor Q3 is as small as possible during intended operation.

In the present configuration, provision is made for the first and the second electrical DC voltage 12, 14 to be connected to one another via a coupling circuit 30. The coupling circuit 30 is intended to be used to ensure, when a disruption occurs in the region of the power supply of the electrical energy source 20 for example, that the second DC voltage 14 or the third DC voltage 46 can be maintained as long as possible so that electric loads connected thereto can transition to a safe operating state and/or back up data. For this purpose, the coupling circuit 30 has a series connection comprising an NPN transistor Q4 and an electrical resistor R13, wherein a collector of the transistor Q4 is connected to a positive electrical potential of the first DC voltage 12 and an emitter is connected via the electrical resistor R13 to the positive electrical potential of the second DC voltage 14. A collector of the transistor Q4 is electrically connected to a base of the transistor Q4 via a resistor R12. Furthermore, the base of the transistor Q4 is electrically connected to the regulation element U260 via a diode D5. The base is connected to an anode of the diode D5, whereas the regulation element U260 is connected to a cathode of the diode D5.

If the second DC voltage 14 drops below a voltage value determined by the construction of the coupling circuit 30, the transistor Q4 transitions to an electrically conductive state such that electrical energy is diverted from the first capacitor 22 to the second capacitor 24. As a result, additional electrical energy is available for the in-phase regulator 28 such that the third DC voltage 46 can be maintained as long as possible if, due to a disruption to the energy supply, the intended operation can only still be maintained to a limited extent. Such a disruption can for example be caused by a voltage failure at the electrical energy source 20 or else by an undervoltage or the like.

So long as the second DC voltage 14 is sufficiently greater with respect to an electrical voltage present at the voltage reference U260, the coupling circuit 30 is in the switched-off switching state. Only when the second DC voltage 14 is small enough does the coupling circuit 30 transition to the electrically conductive state. The coupling circuit 30 thus carries out a fourth comparison.

In the present configuration, provision is furthermore made for the first, the second and the third DC voltage 12, 14, 46 to use the same electrical reference potential.

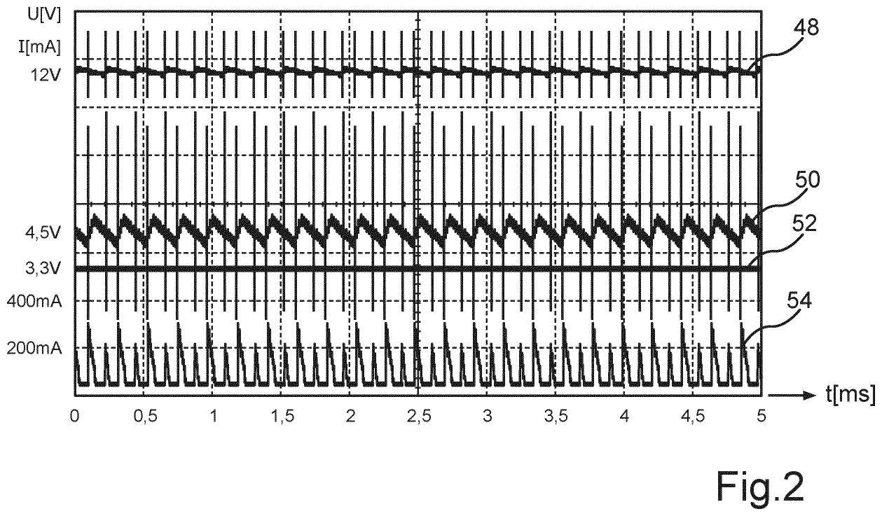

FIG. 2 shows, in a schematic diagram illustration, using graphs 48, 50, 52, 54, temporal signal characteristics of the first, second and third DC voltage 12, 14, 46 and, using the graph 54, a temporal characteristic of the electric current of the storage inductor 18. In the present configuration, provision is made for the graph 48 to illustrate a voltage characteristic of the first DC voltage 12, whereas a graph 50 illustrates the voltage characteristic of the second DC voltage 14. Graph 52 illustrates the voltage characteristic of the third DC voltage 46. The abscissa is assigned to the time axis of the time in ms. It can be seen that the first DC voltage 48 is regulated to approximately 12 V by means of the converter switching unit 16. On the basis of the graph 50, it can be seen that the second DC voltage 14 fluctuates about the voltage value of 4.5 V approximately in a sawtooth shape. In this case, however, the second DC voltage 14 usually remains greater than approximately 4 V. The third DC voltage 46, illustrated by means of graph 52, is adjusted with high accuracy to a DC voltage of approximately 3.3 V. A sufficient voltage reserve therefore remains for the in-phase regulator 28 in order to be able to regulate the third DC voltage 46 to the desired value in a reliable manner. At the same time, the second DC voltage is small enough that the power loss at the in-phase regulator 28, in particular at the transistor Q3, remains as low as possible.

Graph 54 illustrates the electric current of the storage inductor 18. It can be seen that temporally successive current pulses of approximately 200 mA to approximately 300 mA occur at the peak. The current pulses are used to charge the first and second electrical capacitors 22, 24 accordingly—as explained previously.

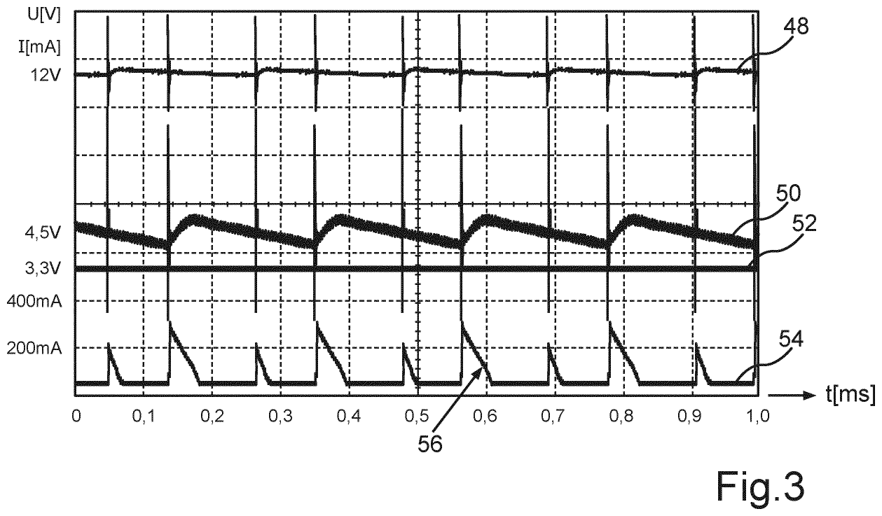

FIG. 3 shows, in a schematic diagram illustration as in FIG. 2 but in an extended temporal resolution, the signal characteristics as explained previously on the basis of FIG. 2. It can be seen that a bend in the sawtooth-shaped characteristic of the current according to graph 54 occurs at a point 56, for example. At this point, the thyristor functional unit 38 is switched into the switched-off switching state; in particular, the transistor 40 is switched off. The current flow therefore commutates as already explained previously on the basis of FIG. 1.

FIGS. 2 and 3 show the signal characteristics in the case of a predefined loading situation of the DC voltages 12, 14, 46. In the present case, provision is made for the first DC voltage 12 to be loaded with an electric current of approximately 5 mA. The third DC voltage 46 is loaded with a current of approximately 30 mA.

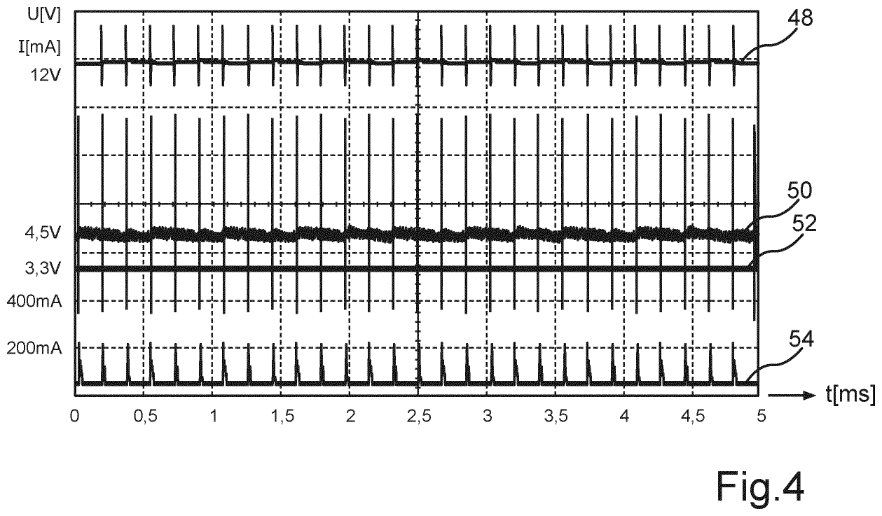

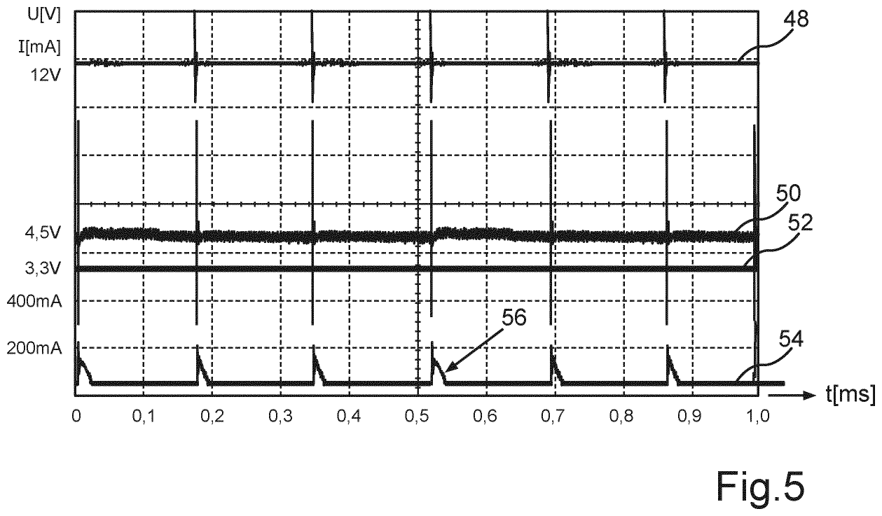

FIGS. 4 and 5 show schematic diagram illustrations corresponding to the schematic diagrams according to FIGS. 2 and 3 but now for a sleep mode or standby mode. In this operating state or mode, the first DC voltage is essentially unloaded. However, energy consumption for the intrinsic energy supply of the converter switching unit 16 still exists. The current consumption for the converter switching unit 16 can be in a range from approximately 0.3 mA to approximately 5 mA. The third DC voltage 46 is loaded with approximately 3 mA in this operating state. This results in the corresponding voltage characteristics or current characteristics illustrated on the basis of FIGS. 4 and 5.

It is apparent from the figures that, on account of the low energy demand, a clock-pulse rate of the converter switching unit 16 is considerably reduced. Furthermore, it also arises that fluctuation of the second DC voltage 14 according to graph 50 is considerably smaller. 56 again denotes a commutation point at which the thyristor functional unit 38 changes to the switched-off switching state.

Even if the thyristor functional unit 38 is formed by a transistor circuit in the present case, a thyristor element can also be provided in principle. However, the presently selected thyristor functional unit 38 with discrete transistors 40, 42 has the advantage that it can be easily adjusted with regard to its properties, for example with regard to the holding current or the like. In addition, a high switching speed can also be achieved.

Overall, the following advantages can be achieved with various embodiments of the present disclosure:
low costs,
compact design, in particular because only a single storage inductor is required,
good availability of the necessary components, in particular because no specific components are required,
high efficiency during the intended operation and also in standby mode,
full compliance with a Dexal standard,
good stability for both DC voltages, in particular because of independent control operations with regard to the first DC voltage and the second DC voltage,
compact size, in particular due to small electrical capacitors with a sufficiently high frequency with regard to the joint use of the electric current of the storage inductor,
high voltage accuracy and in particular low ripple for the third DC voltage when an in-phase regulator is used for the third DC voltage.

### LIST OF REFERENCE SIGNS

10 energy converter
12 first DC voltage
14 second DC voltage
16 converter switching unit
18 storage inductor
20 electrical energy source
22 first electrical capacitor
24 second electrical capacitor
26 secondary switching unit
28 in-phase regulator
30 coupling circuit
32 power converter unit
34 diode
36 diode
38 thyristor functional unit
40 transistor
42 transistor
44 electrical resistor
46 third DC voltage
48 graph
50 graph
52 graph
54 graph
56 point
58 control unit
C2 capacitor
D1, D4, D5 diode
R2, R3, R5 to R13 resistor
Q3, Q4 transistor
U260 voltage reference

What is claimed is:

1. A method for providing two mutually different electrical DC voltages by a clocked energy converter, wherein a first of the two DC voltages, which has a greater voltage value than a second of the two DC voltages, the method comprising:
applying electrical energy from an electrical energy source to a storage inductor of an energy converter using a converter switching unit of the energy converter;
supplying an electric current from the storage inductor to a first electrical capacitor, where the first DC voltage is provided, based on a switching state of a secondary switching unit in response to the secondary switching unit occupying a first switching state;
suppling the electric current from the storage inductor to a second electrical capacitor based on the switching state of the secondary switching unit in response to the secondary switching unit occupying a second switching state; and
providing the second DC voltage at the second electrical capacitor;
wherein the converter switching unit is configured to be controlled based on a result of a first comparison of the first DC voltage with a first voltage comparison value,
wherein the switching state of the secondary switching unit is controlled based on a result of a second comparison of the second DC voltage with a second voltage comparison value.

2. The method as claimed in claim 1,
wherein the switching state of the secondary switching unit is controlled independently of a switching operation of the converter switching unit.

3. The method as claimed in claim 1, wherein the switching state of the secondary switching unit is controlled depending on a result of a third comparison of the electric current of the storage inductor with a current comparison value.

4. The method as claimed in claim 1, wherein the switching state of the secondary switching unit is controlled depending on an operating state of an in-phase regulator unit connected to the second electrical capacitor.

5. The method as claimed in claim 1, wherein electrical energy of the first electrical capacitor is supplied to the second electrical capacitor via a coupling circuit depending on a result of a fourth comparison of the second DC voltage with a third voltage comparison value.

6. The method as claimed in claim 1, wherein the second DC voltage is regulated by means of the secondary switching unit to a voltage value greater than a minimum electrical voltage required for intended operation of the in-phase regulator unit.

7. The method as claimed in claim 1, wherein a clock-pulse rate of the secondary switching unit is greater than half a clock-pulse rate of the converter switching unit on average over time.

8. The method as claimed in claim 1,
wherein the second voltage comparison value selected is a value at least 1 V lower than the first voltage comparison value.

9. A clocked energy converter for providing two mutually different electrical DC voltages, the clocked energy converter comprising:
a converter switching unit capable of being electrically coupled to an electrical energy source,
a storage inductor electrically coupled to the converter switching unit, and
at least one first electrical capacitor for providing a first of the two DC voltages which has a greater voltage value than a second of the two DC voltages,
wherein the first electrical capacitor is electrically coupled to the storage inductor,
wherein the clocked energy converter is configured to control operation of the converter switching unit based on a result of a first comparison of the first of the two DC voltages with a first voltage comparison value,
wherein the clocked energy converter further comprises:
a second electrical capacitor for providing the second DC voltage,
a secondary switching unit electrically coupled to the storage inductor and to the first and second electrical capacitors and configured to supply the electric current of the storage inductor either to the first electrical capacitor or to the second electrical capacitor based on a switching state of the secondary switching unit, and
wherein the energy converter is designed to control the switching state of the secondary switching unit based on a result of a second comparison of the second DC voltage with a second voltage comparison value.

10. The clocked energy converter as claimed in claim 9,
wherein the secondary switching unit comprises a power converter unit.

11. The clocked energy converter as claimed in claim 10,
wherein the power converter unit has at least two diodes,
comprising anode electrodes or cathode electrodes which are electrically connected to one another and to the storage inductor,
wherein the respective other electrodes of the at least two diodes are electrically coupled to the respective one of the first and second electrical capacitors.

12. The clocked energy converter as claimed in claim 9,
wherein the secondary switching unit comprises a thyristor functional unit which is at least in part connected in series with the power converter unit with regard to the electric current supplied to the second capacitor.

13. The clocked energy converter as claimed in claim 12,
wherein the thyristor functional unit comprises a thyristor circuit arrangement including two bipolar transistors and at least one electrical resistor which is electrically coupled to a collector of one of the two bipolar transistors, wherein the thyristor circuit arrangement is configured to adjust a holding current of the thyristor functional unit by means of the electrical resistor.

14. The clocked energy converter as claimed in claim 13,
wherein the thyristor circuit arrangement comprises a stabilization capacitor which is connected at least between the collector of one of the two bipolar transistors and an emitter of an other one of the two bipolar transistors.

15. The clocked energy converter as claimed in claim 12, further comprising a potential circuit designed to apply a predefined electrical potential to a control connection of the thyristor functional unit during intended operation.
